(19) United States
(12) Patent Application Publication
(10) Pub. No.: US 2026/0364881 A1
(43) Pub. Date: Nov. 19, 2026

(54) MULTI-EXTRUDER ADDITIVE MANUFACTURING WITH HIGH THROUGHPUT AND PRECISE DEPOSITION CONTROL

(71) Applicant: Electroimpact, Inc., Mukilteo, WA (US)

(72) Inventors: Ryan L. BISCHOFF, Shoreline, WA (US); Andrew PURVIS, Mukilteo, WA (US); John NANCARROW, Mukilteo, WA (US); Jay WEEKS, Mukilteo, WA (US)

(21) Appl. No.: 19/679,560

(22) Filed: May 15, 2026

Related U.S. Application Data
(60) Provisional application No. 63/806,567, filed on May 15, 2025.

(51) Int. Cl. B29C 64/321; B29C 48/02; B29C 48/285; B29C 48/37; B29C 64/118; B29C 64/209; B29C 64/343; B29C 64/393; B33Y 10/00; B33Y 30/00; B33Y 50/02

(52) U.S. Cl. CPC B29C 64/321; B29C 48/02; B29C 48/297; B29C 48/37; B29C 64/118; B29C 64/209; B29C 64/343; B29C 64/393; B33Y 10/00; B33Y 30/00; B33Y 50/02

(57) ABSTRACT

An additive manufacturing deposition head, machine, and method achieve both high throughput and precise deposition control across a wide operating range. The deposition head includes multiple extruders, and one or more metering pumps positioned downstream of at least one extruder. Material flows from the extruder(s), through the metering pump(s), and exits via a nozzle connected downstream. An associated additive manufacturing machine includes a deposition head, a motion system, and a control system that is configured to manage outputs of extruders and metering pumps to achieve a desired deposition rate.

### CROSS-REFERENCE TO RELATED APPLICATIONS

This application claims benefit of priority to copending U.S. Provisional Patent Application No. 63/806,567 filed May 15, 2025, the contents of which are incorporated herein by reference.

### BACKGROUND

Additive manufacturing is increasingly utilized for rapid prototyping and the production of large parts, driving a need for enhanced build speeds and greater part size capabilities. A significant challenge persists, however, in simultaneously achieving high material deposition rates while maintaining precise volumetric control over the deposited material volume across a broad spectrum of deposition rates. This challenge becomes more pronounced when producing parts that require both large sections deposited rapidly and fine, detailed features requiring high precision, a combination that is difficult for conventional systems with a single deposition head to address efficiently. These single-extruder additive manufacturing systems are limited in their maximum throughput by the physical constraints of extruder screw size and motor power. Moreover, these systems often exhibit a non-linear relationship between extruder screw speed and material output, particularly at lower speeds, making precise control difficult and unpredictable. Conventional systems also primarily depend on the pressure generated by screw rotation to manage deposition output. This approach lacks the fine control necessary for consistent material flow, especially when deposition rates vary, when transitioning between high and low flow rates, or when encountering material inconsistencies. Furthermore, to accommodate the wide range of deposition rates and resolutions required for different parts, or distinct sections within a single part, conventional additive manufacturing systems often necessitate switching between multiple, specialized deposition heads; for example, a deposition head designed for high-throughput, large-volume deposition typically lacks the precision needed for fine details, while a head optimized for fine detail proves unacceptably slow for depositing large, coarse features.

### SUMMARY OF THE DISCLOSURE

This Summary introduces a selection of concepts in a simplified form in order to provide a basic understanding of some aspects of the present disclosure. This Summary is not an extensive overview of the disclosure and is not intended to identify key or critical elements of the disclosure or to delineate the scope of the disclosure. This Summary merely presents some of the concepts of the disclosure as a prelude to the Detailed Description provided below.

According to an embodiment, a deposition head for an additive manufacturing machine features multiple extruders. Positioned after at least one of these extruders, in the material flow path, are one or more metering pumps. This flow path directs additive manufacturing material from the extruder(s) through at least one of the metering pump(s) and then to a nozzle located further downstream. The deposition head also includes a mounting structure designed to attach to the motion system of an additive manufacturing machine.

According to an embodiment, an additive manufacturing machine (AMM) includes a deposition head that comprises multiple extruders, one or more metering pumps positioned in the flow path after at least one extruder, with the flow path directing additive manufacturing material from the extruder(s) through the metering pump(s), and a nozzle located downstream from the metering pump(s). The AMM further includes a motion system that moves the deposition head relative to a deposition surface, and a control system. This control system manages the output of both the extruders and the metering pump(s) to achieve a specific, desired deposition rate from the nozzle.

According to an embodiment, a method of additive manufacturing uses a deposition head equipped with multiple extruders, one or more metering pumps located downstream from at least one extruder, and a nozzle downstream from the pumps. The method includes directing additive manufacturing material from the extruder(s), through the metering pump(s), and out the nozzle. A control system regulates the output of the extruders and the metering pumps to reach a desired deposition rate at the nozzle while depositing the material onto a deposition surface. During deposition, the head is moved relative to the deposition surface.

Further scope of applicability of the presently disclosed devices and methods will become apparent from the Detailed Description given below. However, it should be understood that the Detailed Description and specific examples, while indicating preferred embodiments of the presently disclosed devices and methods, are given by way of illustration only, since various changes and modifications within the spirit and scope of the devices and methods will become apparent to those skilled in the art from the Detailed Description.

### BRIEF DESCRIPTION OF THE DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is an overview diagram showing an additive manufacturing machine (AMM), in a build cell, with a multi-extruder deposition head, according to an embodiment.

FIG. 2 is a perspective view of an additive manufacturing deposition head according to an embodiment, showing plural extruders arranged in parallel, each with a corresponding metering pump.

FIG. 3 is a perspective view of an additive manufacturing deposition head according to another embodiment, showing plural extruders arranged in parallel, with the extruders paired, each pair coupled to a dedicated metering pump feeding a common nozzle downstream.

FIG. 4 is a perspective view of an additive manufacturing deposition head according to a further embodiment, showing a plurality of extruders, each with a corresponding metering pump, and a mixer positioned downstream of the extruders.

FIG. 5 is a plot illustrating an example control logic strategy for a multi-extruder deposition head, according to an embodiment.

FIG. 6 is an exploded view of a deposition head, showing the individual components and their assembly, according to an embodiment.

FIG. 7 is a perspective view of an additive manufacturing deposition head according to an embodiment.

FIG. 8A, FIG. 8B, and FIG. 8C are perspective views of a multi extruder deposition head incorporating a material feed selection system in respective states, according to an embodiment.

FIG. 9 is a perspective view of an example part geometry constructable using a multi-extruder deposition head, according to an embodiment.

FIG. 10 is a block diagram illustrating the relationship between a deposition head, a nozzle outlet, newly deposited additive manufacturing material, a substrate, and a deposition surface, according to an embodiment.

FIG. 11A and FIG. 11B are block diagrams illustrating control system architectures for an additive manufacturing machine, according to an embodiment, showing distribution of control functions between a main controller and a deposition head controller.

### DETAILED DESCRIPTION

Various examples of the disclosed devices and methods will now be described. The following description provides specific details for a thorough understanding and enabling description of these examples. One skilled in the relevant art will understand, however, that the presently disclosed devices and methods may be practiced without some of these details.

Likewise, one skilled in the relevant art will also understand that the presently disclosed devices and methods can include many other features not described in detail herein. Additionally, some well-known structures or functions may not be shown or described in detail below to avoid unnecessarily obscuring the relevant description.

Descriptions of well-known starting materials, processing techniques, components and equipment may be omitted so as not to unnecessarily obscure the key details. It should be understood, however, that the detailed description and the specific examples, while indicating (e.g., preferred) embodiments, are given by way of illustration only and not by way of limitation. Various substitutions, modifications, additions and/or rearrangements within the spirit and/or scope of the underlying inventive concept will become apparent to those skilled in the art from this disclosure.

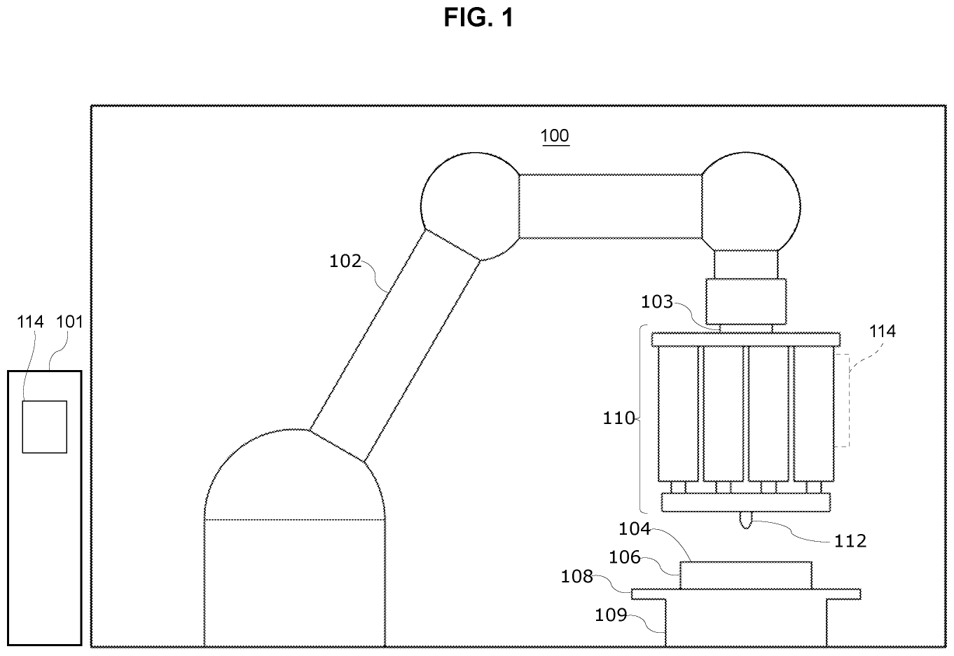

In general, similar reference numbers in the figures and the description below refer to the same or similar features. For example, element 110 in FIG. 1 is a deposition head and elements 210, 310, 410, etc. in subsequent figures are also deposition heads, and may be the same deposition head as 110 except where explicitly or practically distinct.

FIG. 1 is an overview diagram illustrating an additive manufacturing build cell 100 that includes an additive manufacturing machine (AMM) motion system 102, an articulated robot in this embodiment, which is connected to a deposition head 110 comprised of a plurality of extruders (contained within the deposition head 110) and at least one metering pump (contained within the deposition head 110). The deposition head connects to the motion system 102 through a deposition head mounting structure 103. The mounting structure 103 provides the primary mechanical interface between the motion system 102 and the deposition head 110, and may be a permanent fixture or feature set configured to mechanically couple the deposition head 110 to the motion system 102 to integrate the deposition head with the AMM and its motion system 102. In some embodiments, the mounting structure 103 can be configured such that the deposition head 110 can be detached and attached from the motion system 102 (often using a tool changer interface). This mounting structure 103 may permit the motion system 102 to alternately connect with any of a variety of other end effectors including an AFP) end effector (not shown) or a milling end effector (not shown) after the mounting structure 103 is disconnected from the deposition head 110. This mechanical coupling interface 103 may also include pathways for electrical, pneumatic, hydraulic, and/or other fluid connections between the deposition head 110 and the motion system 102 or the broader AMM infrastructure, facilitating power transmission, control signals, material transfer and/or coolant transfer.

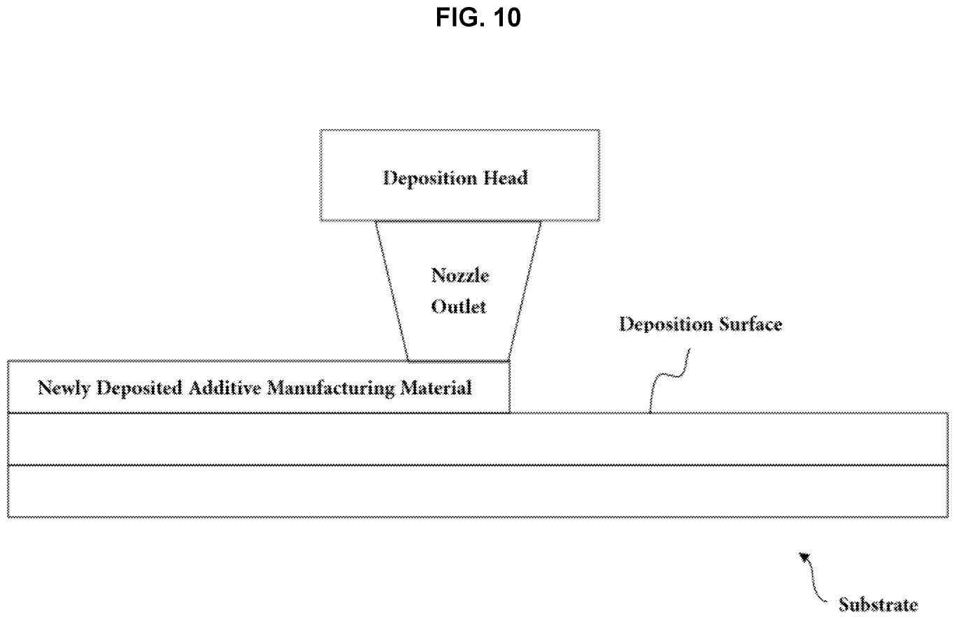

The build cell 100 further includes a deposition surface 104, which is the surface of the substrate 106 upon which new material is extruded (as further detailed in FIG. 10), which may comprise a build plate 108, a partially built part, previously deposited material, or a combination thereof. The substrate 106 represents the underlying structure receiving the newly deposited material. For smaller build cells or for smaller parts, the build plate 108 may be attached to or integrated with a part rotator 109. In larger build cells or for larger parts, the build plate 108 may be large and cover a substantial part of the floor space of the build cell 100. The part rotator 109 may be temperature controlled (typically heated), and may rotate, with its rotation coordinated by a control system such as, but not limited to, a control system described below. During operation, the deposition head 110 deposits material dispensed from a nozzle 112 onto the deposition surface 104. While specific embodiments described herein may show certain types or numbers of extruders, it is understood that the deposition head 110 may incorporate various types of extruders, including pellet, filament, powder, or liquid resin extruders, or combinations thereof, each potentially optimized for different material types or throughput characteristics. Furthermore, while some configurations may receive material from an off-board source via a feed tube, certain extruder types may incorporate their material storage directly on the deposition head; for example, filament extruders (commonly used in Fused Filament Fabrication or FFF) may utilize on-head spool mounts, or pellet extruders may employ small, integrated pellet hoppers. Although an articulated robotic arm is depicted as the AMM motion system 102 in this illustration, alternative configurations, such as gantry systems or other motion platforms, including those with movable build plates, are also contemplated.

The AMM includes a control system 114 that coordinates the operation of the AMM motion system 102 and the deposition head 110. This control system 114 includes the hardware and software components configured to execute the additive manufacturing process, which may include comprising components such as: one or more processing units (e.g., computer numerical controls (CNCs), microcontrollers, programmable logic controllers (PLCs), industrial PCs, or embedded processors); memory; input/output (I/O) interfaces; sensors (for process monitoring, feedback, safety, etc.); actuators and associated drives; power electronics; communication networks (wired or wireless potentially using protocols like EtherCAT, PROFINET, CAN bus, etc.); and the associated software, firmware, or control logic.

The architecture of the control system 114 may vary. For example, the control system 114 may be centralized with a single primary controller managing substantially all functions of both the motion system 102 and the deposition head 110. Alternatively, the control system 114 may be distributed, involving multiple cooperating controllers. For example, a main controller associated with the AMM motion system 102 may be configured to handle overall path planning, system coordination, and user interface functions while a deposition head controller associated with the deposition head 110 may be configured to monitor and control parameters of the deposition head as described in greater detail below. The main controller may also communicate with one or more dedicated controllers located on or integrated within the deposition head 110 which manage real-time, localized functions such as the precise operation of the plurality of extruders, the one or more metering pumps, heaters, and ancillary systems based on commands received from the main controller and/or local sensor feedback. Such distribution can improve real-time performance and modularity. Hybrid architectures are also contemplated.

The physical location of the control system 114 components may vary. Components such as processing units, I/O modules, drives, sensors, and supporting circuitry may be physically integrated within the deposition head 110 structure (e.g., as shown in broken lines in FIG. 1), mounted elsewhere on the AMM motion system 102 (e.g., on the robot arm or gantry structure), housed within a separate control cabinet 101 associated with the AMM build cell 100 as shown in solid lines in FIG. 1, or distributed across any combination of these locations. For instance, a main controller may be located off the deposition head, however, essential I/O, signal conditioning, power drivers, or local microcontrollers for specific tasks (like sensor data pre-processing or closed-loop pump control) may be located directly on the deposition head 110 to enhance performance, increase modularity, and/or simplify wiring.

Regardless of the specific architecture or component placement, the overall control system 114 may operate as a coordinated collection of sub-systems (e.g., distinct motion control and deposition process control sub-systems) to manage the overall AMM operation. Such management includes controlling the movement of the AMM motion system 102 relative to the deposition surface 104, controlling activation states and output rates of the individual extruders and the one or more metering pumps within the deposition head 110, managing thermal conditions, processing sensor data, and synchronizing operations to accurately deposit material according to the desired build path and parameters. The control system may further incorporate advanced features such as machine learning algorithms for predictive process adjustments based on sensor fusion, real-time kinematic compensation tied to deposition rate changes, or integration with higher-level Manufacturing Execution Systems (MESs) for build monitoring and data logging. This allows for achieving the desired part geometry, material properties, and build efficiency.

When employing extruders for materials that do not require melting, such as liquid resins or powders, certain system adaptations may be beneficially implemented. For example, a metering pump may be selected for compatibility with a specific material's viscosity and other characteristics. While positive displacement pumps (such as gear pumps) are often preferred for thermoplastic melts due to their ability to handle high viscosity and they generate pressure for precise volumetric control, a suitable positive displacement pump designed for resins or powders (e.g., certain types of gear pumps, progressive cavity pumps, lobe pumps, or diaphragm pumps) might be used instead of one optimized solely for high-temperature melts. This ensures that the principle of precise downstream volumetric metering is applicable across various material types. Similarly, upstream material handling for powders, slurries, or resins would differ from pellet or filament feeding. Additionally, nozzle designs may be adapted for the specific material characteristics and deposition requirements.

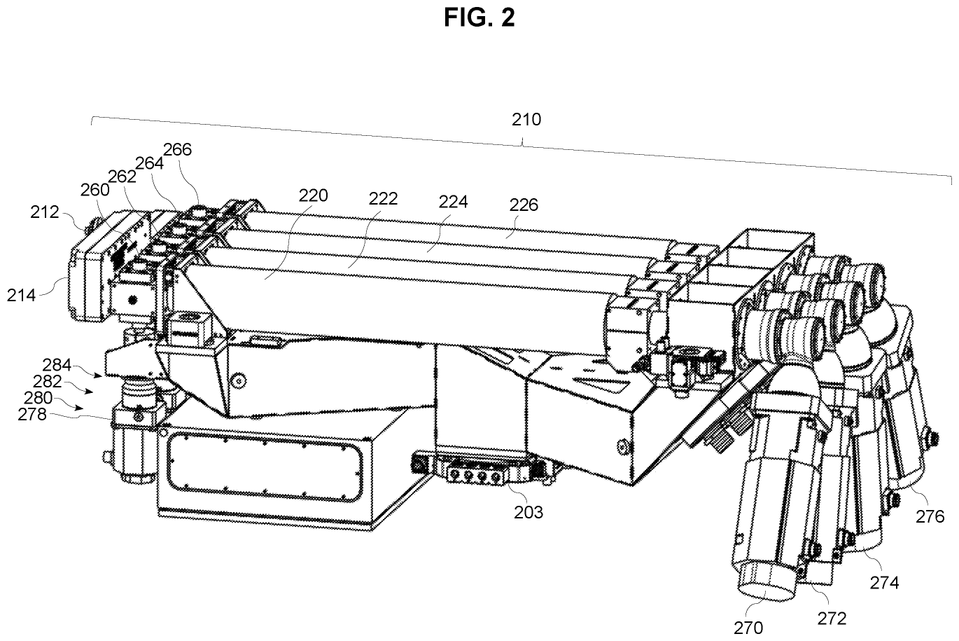

FIG. 2 is a diagram of an additive manufacturing deposition head 210 according to an embodiment. The deposition head 210 includes four extruders 220, 222, 224, 226 (the barrels being labeled respectively) arranged functionally in parallel. ‘Functionally parallel’ indicates that the extruders may operate independently or concurrently to contribute to the overall material output towards the nozzle, regardless of the specific physical arrangement (e.g., side-by-side, in a circle, clustered). In some embodiments, the plurality of extruders may be heterogeneous, comprising extruders with different maximum throughput capacities, screw designs, or even different feed types (e.g., combining pellet and filament extruders) within a single deposition head 110. This heterogeneity can be leveraged by the control system 114 to further optimize performance across an extremely wide dynamic range of applications. For instance, the control system 114 could activate a smaller, faster-heating extruder with lower throughput for printing fine, detailed features requiring rapid starts and stops, while engaging larger-capacity extruders primarily for high-volume infill sections of a part.

Each extruder is driven by a respective motor 270, 272, 274, 276. While, in the illustrated embodiment, four extruders 220, 222, 224, 226 are mounted side-by-side and are physically parallel, it is understood that any plurality of extruders (two or more) can be used. In this embodiment, each extruder is fluidly connected downstream to a corresponding metering pump: i.e., extruder 220 is coupled to metering pump 260, extruder 222 is coupled to metering pump 262, extruder 224 is coupled to metering pump 264, and extruder 226 is coupled to metering pump 266. Each extruder includes an integrated screw (not shown as they are disposed within the respective barrels) driven by its respective motor, and the illustrated barrel. Each metering pump 260, 262, 264, 266 is driven by a corresponding dedicated motor 278, 280, 282, 284, respectively. A control system (e.g., 114 in FIG. 1) may control each extruder motor 270, 272, 274, 276 and metering pump motor 278, 280, 282, 284 independently or collectively.

The deposition head 210 may include a mounting structure 203 configured for mechanical attachment of the deposition head 210 onto an additive manufacturing machine (AMM) motion system 102. A robotic tool changer interface is one example of such a mounting structure 203. While primarily providing mechanical connection, the mounting structure 203 may optionally include interfaces for electrical, pneumatic, and/or fluid couplings between the deposition head 210 and the AMM motion system. Mounting structures 203 are contemplated with or without such additional coupling capabilities.

A manifold 214 may be employed to combine material outputs from metering pumps 260, 262, 264, 266. A single nozzle 212 is fluidly connected to the manifold 214. This configuration-where the outputs from the plurality of metering pumps converge via the manifold 214 (or via a mixer) to the single nozzle 212-establishes a well-defined, singular point of material deposition. The exit orifice of nozzle 212 serves as a consistent Tool Center Point (TCP) for the deposition head 210, significantly simplifying path programming and motion control executed by the AMM control system and motion system. Although the same extruder type is shown for all four extruders in FIG. 2, different sizes or types of extruders (e.g., combining pellet and filament extruders, or extruders with different screw designs or capacities) may, as described above with respect to FIG. 1, be used in parallel within the deposition head 210.

The precise volumetric control provided by the downstream metering pumps 260, 262, 264, 266 is a key advantage when combined with the multiple extruders 220, 222, 224, 226. This combination allows the deposition head 210 to simultaneously achieve the high throughput potential offered by multiple parallel material streams while maintaining the fine deposition control needed for precision and complex geometries across a very wide operating range. As used herein, ‘decoupling’ refers to the functional separation achieved by the metering pump(s), where the upstream extruder(s) primarily focus on melting and consistently feeding sufficient material to the pump inlet while the downstream metering pump(s) independently control the precise volumetric output rate and generate the necessary pressure for deposition through the nozzle, largely irrespective of minor variations in extruder speed or melt pressure delivered to the metering pump inlet.

For example, in a four-extruder system with a combined maximum output of 1000 lb/hr, a typical 20% variation in a single extruder's output (if relying solely on screw speed and pressure control) could result in a 200 lb/hr fluctuation in the overall deposition rate. The precise metering provided by the metering pumps 260, 262, 264, 266 (configured based on the material and pressure requirements), where these are often positive displacement devices (such as melt pumps and gear pumps or potentially other types such as progressive cavity pumps), means the metering pumps 260, 262, 264, 266 are significantly less sensitive to variations in back-pressure, material viscosity, or minor screw feed inconsistencies compared to relying solely on extruder screw rotation for metering. Specifically, positive displacement pumps operate by trapping discrete volumes of material (e.g., between gear teeth or within cavities) and mechanically forcing these volumes from the inlet to the outlet. This mechanism ensures that the output volume per pump revolution is highly consistent and predictable, provided the inlet is sufficiently supplied with material. While positive displacement pumps are often preferred due to their inherent volumetric accuracy and pressure generation capabilities, other pumping mechanisms capable of providing consistent and controllable volumetric flow rates under the required processing conditions (temperature, pressure, viscosity) are contemplated, provided they achieve the necessary decoupling and precision. Furthermore, materials for pump components (e.g., gears, housings) may be selected for appropriate wear resistance and temperature compatibility with specific additive manufacturing materials being processed. This minimizes such variations and promotes accurate and consistent material deposition across the entire operating range of deposition rate. Furthermore, the metering pumps 260, 262, 264, 266 generate the high, stable pressure needed for consistent extrusion through the nozzle 212, largely independent of the upstream extruders' screw speeds, thereby enhancing the previously defined decoupling of the melting/feeding stage from the final pressure generation and metering stage. This decoupling allows the extruder screw primarily to focus on melting and supplying sufficient material to the metering pump's inlet, while the metering pump precisely dictates an output flow rate. This precise, decoupled volumetric control provided by the downstream metering pump directly overcomes the limitations of conventional systems which struggle with flow consistency and pressure-dependent output, particularly over wide deposition ranges.

Metering pumps (such as 260, 262, 264, 266) also enhance flow balancing between the plurality of extruders when their outputs are combined into a common pathway through a mixer, a manifold, or both. In systems without such metering pumps, pressure variations inherent between individual operating extruders can cause undesired backflow, wherein material from a higher-pressure extruder pathway forces its way into a lower-pressure pathway within the common manifold and/or mixer. The metering pumps mitigate this by isolating the extruder screw's pressure generation from the downstream pressure. Each active metering pump draws material from its upstream extruder(s) and positively displaces this material into a manifold, mixer, or joint nozzle at a precisely controlled volumetric rate. This resists pressure fluctuations from other pathways and ensures that each activated extruder contributes its intended share to the total flow without backflow interference, thereby resulting in a more stable, predictable, and balanced combined output.

In a configuration of the embodiment shown in FIG. 2, the four extruders 220, 222, 224, 226 of the deposition head 210 each have a maximum deposition capacity of 250 lb/hr. Throughout this description, ‘deposition rate’ typically refers to mass flow rate (e.g., lbs/hr), although it can be directly related to volumetric flow rate via the material density at processing temperature. Each extruder 220, 222, 224, 226 in the example configuration is a pellet extruder designed to process thermoplastic pellets. The corresponding metering pumps 260, 262, 264, 266 are gear pumps, selected for their precise metering capabilities. The control system (not shown) employs closed-loop feedback to control the speed of each extruder screw via motors 270, 272, 274, 276 and its corresponding metering pump motor 278, 280, 282, 284. This configuration enables a combined maximum deposition rate of 1000 lb/hr (4 extruders×250 lb/hr/extruder) while also maintaining precise control over the deposition rate across a wide range, from near zero up to the maximum. The control system receives a desired deposition rate as an input and automatically adjusts the number of active extruders and speed of each active extruder's metering pump to achieve the target rate.

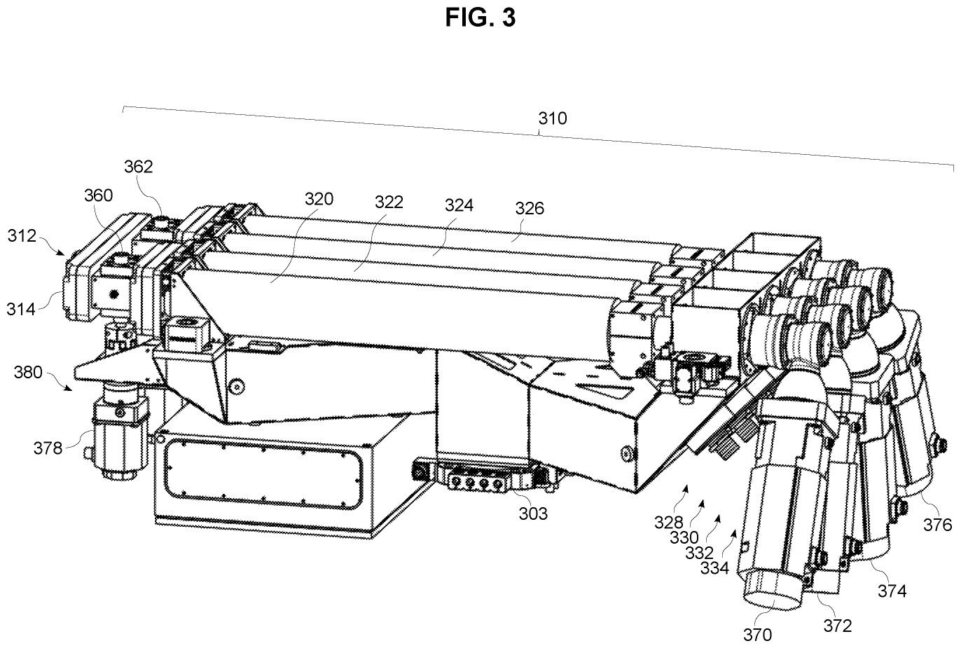

FIG. 3 illustrates an additive manufacturing deposition head 310 according to another embodiment. The deposition head 310 includes four pellet extruders 320, 322, 324, 326 (whose barrels are labeled respectively) arranged functionally in parallel. A first metering pump 360 is fluidly connected downstream of a subset of extruders, e.g., extruders 320, 322, and a second metering pump 362 is fluidly connected downstream of another subset of extruders, e.g., extruders 324, 326. Each extruder 320, 322, 324, 326 includes a material inlet 328, 330, 332, 334, respectively, for receiving additive manufacturing material, which may include associated local hoppers, or direct connections to material feed lines. Each extruder also includes a screw (not shown as they are disposed within the barrel), respectively, and a barrel, respectively. Each metering pump 360, 362 is driven by a motor 378, 380, respectively. A control system is operatively connected to each extruder 320, 322, 324, 326 and to the metering pumps 360, 362 to manage their operation. The deposition head 310 includes a mounting structure 303 for attachment onto an AMM motion system (not shown). Material outputs from metering pump 360 and metering pump 362 are fluidly connected to a nozzle 312 (potentially via a mixer or a manifold). Alternative configurations are contemplated, including arrangements where different numbers of extruders share a single metering pump (e.g., three extruders feed one metering pump, and one extruder feeds another metering pump), or configurations where one or more extruders feed a metering pump while one or more other extruders may feed directly to a manifold or nozzle without passing through a metering pump (although potentially sacrificing precision for those non-pumped extruders).

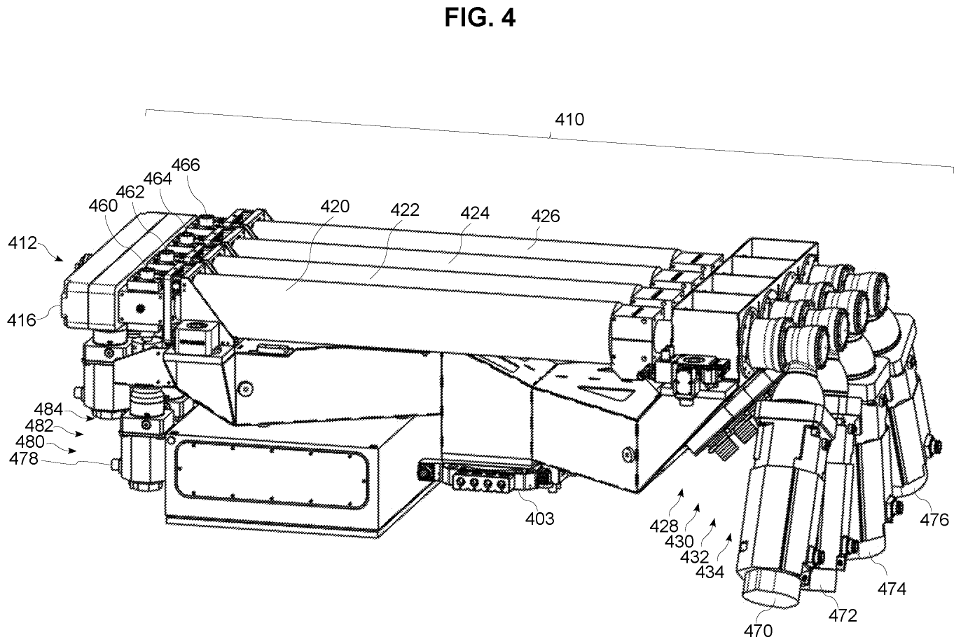

FIG. 4 illustrates an additive manufacturing deposition head 410 according to a further embodiment. The deposition head 410 includes four extruders 420, 422, 424, 426 (the barrels being labeled respectively) arranged functionally in parallel. Each extruder 420, 422, 424, 426 is operatively coupled to a corresponding metering pump: extruder 420 to metering pump 460, extruder 422 to metering pump 462, extruder 424 to metering pump 464, and extruder 426 to metering pump 466. Each extruder 420, 422, 424, 426 includes a material inlet 428, 430, 432, 434, respectively, for receiving material. Each extruder also includes a screw (not shown as they are disposed within the barrel) and a barrel. Each metering pump 460, 462, 464, 466 is driven by a respective motor 478, 480, 482, 484. A control system (not shown) is operatively connected to each extruder 420, 422, 424, 426, to each metering pump 478, 480, 482, 484, and to mixer 416 (if it includes active components). The deposition head 410 includes a mounting structure 403 for attachment onto an additive manufacturing machine (not shown). A mixer 416 is positioned downstream of the metering pumps 460, 462, 464, 466. In the embodiment shown, the mixer 416 also functions as a manifold receiving material outputs from all metering pumps. However, a separate manifold (not shown) could be used upstream or downstream of the mixer. Furthermore, if mixing is not required, a manifold alone (not shown) could combine the outputs from the extruders or metering pumps before delivery to the nozzle 412. The mixer 416 is fluidly connected to a nozzle 412.

It is contemplated that additional additive manufacturing materials (e.g., fillers, colorants, or secondary polymers) may be introduced into the mixer 416 prior to deposition. For a single material, the mixer 416 provides several potential benefits. For instance, it can promote homogeneity by compensating for minor variations in temperature or composition from individual extruders. The (not shown) internal geometry of mixer 416, which may include static mixing elements such as baffles or helical structures or a dynamic mixing element such as a powered screw or rotor, facilitates mixing. This geometry is understood to also induce shear flow, aligning polymer chains and thereby enhancing the strength and interlayer bonding of the deposited part.

Additionally, the mixer 416 may incorporate active cooling, for example, through integrated cooling channels circulating a coolant fluid, connections for forced air cooling, or via other active cooling methods. This controlled cooling lowers the material's temperature before deposition, which contributes to improved dimensional accuracy and reduced warping. In the case of multiple materials, mixer 416 can ensure thorough mixing before deposition. While a multi-material extruder could perform this mixing, the illustrated configuration, having separate extruders feeding the mixer, is advantageous at least when the multiple materials to be mixed are reactive materials. Maintaining material separation until mixer 416 minimizes pre-deposition reaction time. In further embodiments, multiple mixers may be employed, potentially arranged in series for sequential processing steps or in parallel to handle different material combinations or flow paths simultaneously. An appropriate mixer configuration, whether static, dynamic, actively cooled, or arranged in multiples, may be selected based on the materials being processed and the desired part properties.

In an alternative embodiment of the deposition head (e.g., 410), the relative positions of the functional components within the flow path differ from previously described embodiments. For instance, material outputs from a plurality of extruders (such as 420, 422, 424, 426) may first be combined and homogenized in a mixer (such as mixer 416). The single output stream from this mixer may then be fed into at least one metering pump (e.g., a single, larger-capacity metering pump, analogous to metering pump 460) positioned downstream of the mixer and upstream of the final deposition nozzle (e.g., nozzle 412). In such an arrangement, the metering pump precisely meters the total volumetric flow rate of the already mixed material immediately before deposition. Although this configuration places the final metering device closest to the nozzle, it primarily relies on control of the individual extruder screw speeds (e.g., controlling the respective screws 436, 438, 440, 442), rather than intermediate pumps, to achieve the desired material proportions prior to mixing and pumping. Furthermore, in some embodiments the inlet manifold of a mixer is structured to manage the pressure dynamics and minimize potential backflow between the extruders feeding into the common mixer inlet. This inlet manifold configuration may be suitable for applications in which precise control of the final deposition volume of a pre-blended or single material is paramount, and homogenization before final metering is desired.

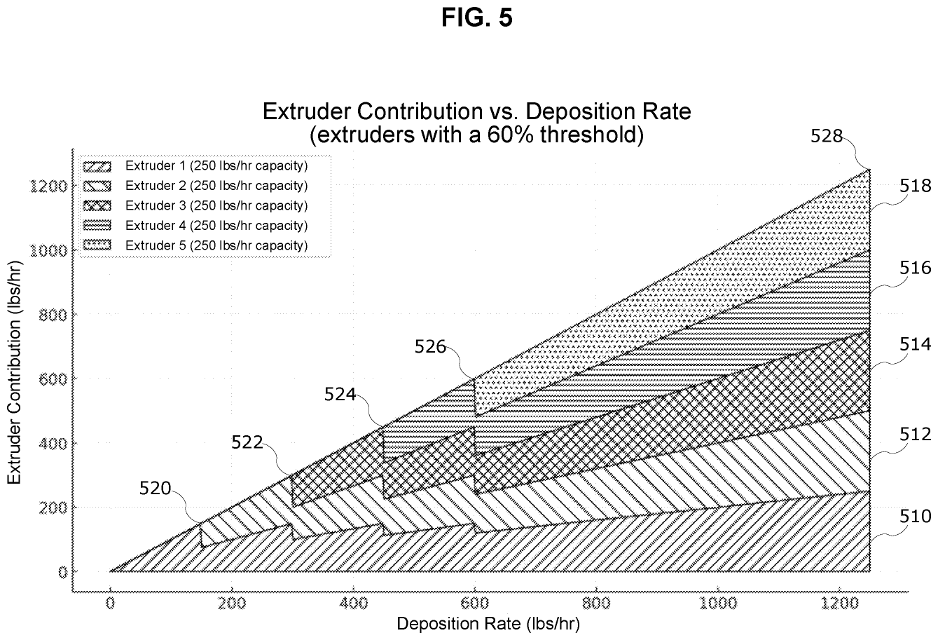

FIG. 5 is a plot illustrating the relationship between total deposition rate and a corresponding target contribution from individual extruders, with the X-axis representing Target Total Deposition Rate in lbs/hr and the stacked areas each representing the contribution rate from an individual extruder in lbs/hr along the Y-axis to achieve an aggregate extruder contribution (the top line). The plot shows an example scenario for a deposition head configured with five extruders (Extruder 1, Extruder 2, Extruder 3, Extruder 4, Extruder 5), each having a maximum capacity of 250 lbs/hr. It will be appreciated that a different plot would result from a different number of extruders and/or different extruder capacities, including nonuniform extruder capacities. For any given target deposition rate on the X-axis, the plot indicates which extruders are intended to be active and the target contribution rate from each, represented by the height of the corresponding stacked contribution area (contribution area for Extruder 1 indicated by 510, Extruder 2 by 512, Extruder 3 by 514, Extruder 4 by 516, and Extruder 5 by 518). This plot represents the intended steady-state contribution for a given target rate, not a dynamic ramp-up over time. The control logic illustrated herein generally activates the minimum number of extruders required to meet the target rate efficiently. Extruder 1, contribution area 510, handles target rates up to a first activation threshold 520 which corresponds to 150 lbs/hr on the X-axis. For target rates above threshold 520 and up to a second activation threshold 522, corresponding to 300 lbs/hr, Extruders 1 and 2, as represented by contribution areas 510, 512, are active. For rates above threshold 522 and up to a third activation threshold 524, corresponding to 450 lbs/hr, Extruders 1, 2, and 3, as represented by contribution areas 510, 512, 514 are active. Extruder 4, contribution area 516, is added for target rates above threshold 524 up to a fourth activation threshold 526 corresponding to 600 lbs/hr, and Extruder 5, contribution area 518, added above threshold 526 up until the maximum deposition rate 528. This activation sequence corresponds to adding the next extruder when the target rate exceeds a nominal threshold (which is 60% in this example, though other percentage thresholds may be implemented) of the combined maximum capacity of the currently active set. Within each active set, the control system generally aims to balance the load across the operating extruders, as suggested by the relatively uniform contributions shown shortly after a new extruder is activated (i.e., shortly after crossing thresholds 520, 522, 524, 526). The control system may also manage transitions between activation states (not illustrated), including, for example, brief ramp-up or ramp-down periods for extruder and pump speeds, or short purging sequences if necessary, to ensure smooth changes in deposition rate. It is noted that for build paths requiring only brief periods at a significantly higher deposition rate than adjacent sections, the control system may prioritize maintaining the current number of active extruders and temporarily operating them above the nominal utilization point (e.g., above the 60% threshold level represented by points 520, 522, 524, or 526), rather than activating an additional extruder for only a short duration. This prioritization avoids unnecessary thermal cycling and potential process delays associated with heating and cooling extruders, and also minimizes the risk of material degradation that can occur when material resides in a heated, inactive extruder. More generally, the control system may be programmed or otherwise configured to adapt the extruder activation and contribution strategy-deviating from the simple threshold model when advantageous-based on analysis of the overall build path, specific part requirements, material properties, or other operational considerations, specifically to minimize the frequency of extruder activation and deactivation. Overall, this configuration allows the system to efficiently handle a wide range of deposition rates specified by the part build instructions while managing energy use and extruder cycling across the full operating range up to 1250 lbs/hr, balancing throughput requirements with operational efficiency and material stability.

In general operation, the control system (e.g., 114) can be programmed or otherwise configured in different ways to manage the plurality of extruders. According to one configuration, the control system may pre-select an operational subset of the plurality of extruders (e.g., Extruder 1, Extruder 2, Extruder 3) prior to starting a build process. In some implementations this pre-selection is based on a maximum anticipated deposition rate required for the entire part, using logic similar to that illustrated in FIG. 5 to determine the minimum number of extruders needed to cover that peak rate while minimizing the number of extruders that must be prepared for operation. Alternatively, or in conjunction with pre-selection, the control system can be configured to dynamically activate and deactivate the specific number of extruders required to achieve the desired deposition rate at any given point during the build process. This dynamic activation can be determined based on the current deposition rate command and the capacity thresholds of the extruders (as exemplified by thresholds 520, 522, 524, 526 in FIG. 5) potentially aiming to balance load, minimize thermal cycling, and/or optimize energy consumption according to predetermined or adaptive control logic. Furthermore, the activation, deactivation, and modulation of extruder and metering pump outputs may also be influenced or directly controlled based on real-time feedback from one or more sensors to further optimize performance, quality, or process stability. Such sensors may include, but are not limited to: an inspection camera, a laser displacement sensor, a profile scanner, a temperature sensor, a pressure sensor, a material level sensor, and a motor torque sensor (e.g. for the motors for the extruders, metering pumps, or mixers).

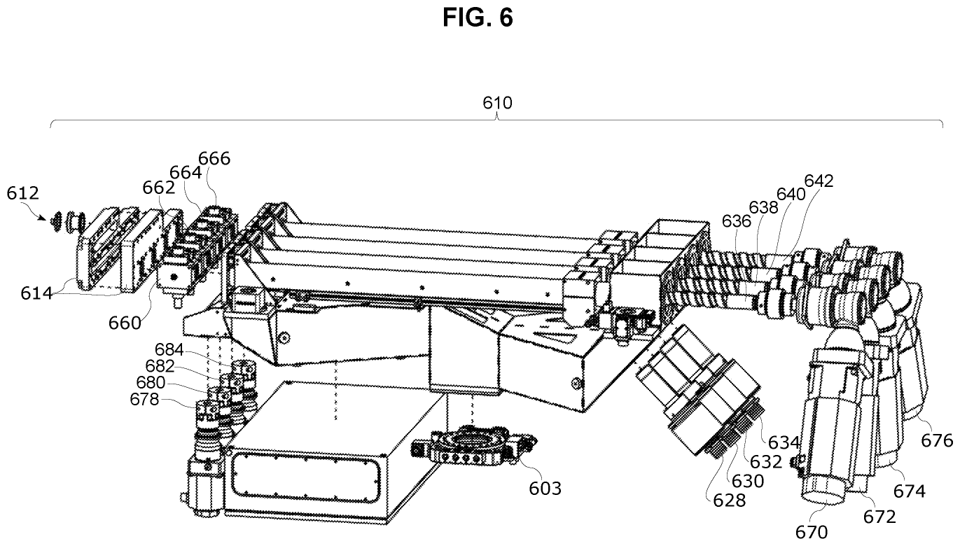

FIG. 6 illustrates an exploded view of a deposition head 610, showing various individual components and their assembly. Components shown include: four extruders as labeled by their internal screws 636, 638, 640, 642; four corresponding metering pumps 660, 662, 664, 666; four material inlets 628, 630, 632, 634 for feeding material to the extruders; four extruder motors 670, 672, 674, 676 for driving the screws; four metering pump motors 678, 680, 682, 684 for driving the metering pumps; a mounting structure 603 for attachment of the deposition head to a motion system (e.g., 102 in FIG. 1); a manifold 614; and a single nozzle 612.

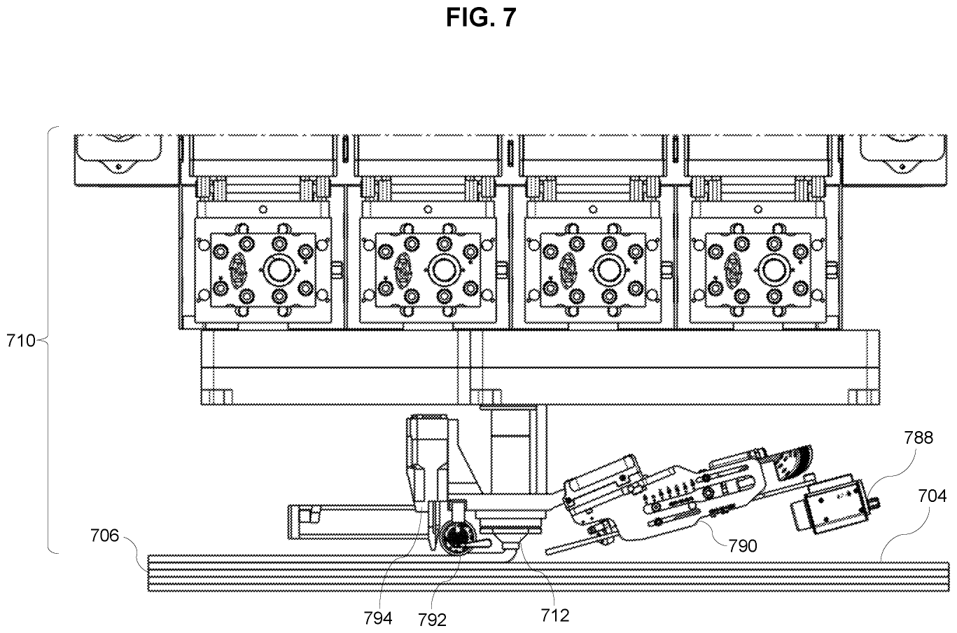

FIG. 7 provides a side view of an additive manufacturing deposition head 710 in a deposition state and having ancillary components for process control and part quality, according to an embodiment. A deposition nozzle 712 is coupled to the deposition head 710 for material deposition. A temperature sensor 788 is positioned proximate to a deposition zone (region of substrate or prior deposition where new deposition will be placed), ahead of the nozzle 712 relative to a deposition travel direction (from left to right in FIG. 7). The temperature sensor 788 is configured to measure the temperature of a deposition surface 704 and/or an underlying substrate 706 to facilitate improved interlayer bonding. The temperature sensor 788 may comprise, for example, an infrared pyrometer, a thermopile, or a thermocouple. In some embodiments, another temperature sensor (not shown) may be positioned proximate to the deposition zone, but behind the nozzle, to measure the temperature of newly deposited additive manufacturing material or temperatures of various components on the deposition head 710. Furthermore, temperature sensors (not shown) disposed within or externally to the extruder(s) may be employed to provide temperature feedback of various locations on the extruder, the additive manufacturing material within the extruder, and the nozzle 712, according to some embodiments. Other sensors, such as inspection cameras for monitoring deposition quality or geometry, and laser displacement sensors or profile scanners for measuring layer height, geometry, or overall part dimensions during the build, may also be included as part of an integrated sensor system.

A localized laser heater 790 may in some embodiments be positioned ahead of the nozzle 712 according to the nozzle's direction of deposition. The heater 790 provides localized heating to the substrate 706 immediately prior to deposition to promote optimal bonding of the material to the substrate. Alternative heating methods, such as hot air blowers, infrared heaters, or conductive heating elements, may alternatively or additionally be used. In some embodiments a compaction roller 792 may be disposed to trail the nozzle 712 and may be placed and oriented to apply pressure to a newly deposited material layer (not numbered) to improve interlayer adhesion and geometric conformance. The roller 792 may optionally be heated or cooled. Other compaction devices, including a ring, plate, or shoe, may be used instead of a roller. A reinforcement applicator 794 is shown, configured to place reinforcement material within the newly deposited material. In this embodiment, the applicator 794 is shown to place structural pins tangent to the deposition surface. However, the reinforcement applicator may be configured for various reinforcing materials (e.g., continuous fiber, chopped fiber tape, towpreg) or may be oriented differently relative to the deposition surface. Optionally, a surface treatment applicator (not shown) may be included, typically positioned ahead of the nozzle 712, to apply bonding agents, primers, or other preparations to the substrate to enhance adhesion or modify surface properties. Various methods (e.g., plasma treatment, adhesive spraying) are possible. The number, type, and arrangement of ancillary components shown are exemplary; other combinations and arrangements are possible, including combinations such as upstream heating/sensing combined with downstream compaction for optimized layer bonding and density. Additionally, a cooling block (not shown), potentially liquid-cooled, may be incorporated into the deposition head 710 to manage heat and protect head components and the AMM motion system. Operation of these ancillary systems is typically coordinated by the main control system or the deposition head controller (1206) in conjunction with the deposition process.

The control system (e.g., 114) may monitor and/or control temperature at various critical points to maintain desired material properties, deposition quality, and process stability. Monitored/controlled locations may include: within an extruder barrel to achieve target melt conditions; within a metering pump to maintain target viscosity and prevent thermal degradation or solidification; within a mixer (which may include active cooling) to ensure homogeneity, manage exothermic reactions, and/or reach a target deposition temperature; at or near the nozzle to optimize exit flow characteristics and prevent issues like the solidifying of additive manufacturing material obstructing flow to the nozzle; on the substrate prior to deposition to promote adhesion; and/or on the newly deposited material (e.g., using roller 792). Furthermore, the overall temperature of the deposition head (e.g., 710) itself may also be managed, for instance using the cooling block, to protect components and maintain stable operating conditions for the extruders and pumps. For example, the control system may dynamically adjust one or more operational parameters, including output of the localized heater 790, a deposition rate, or a deposition head traversal speed, based at least partly on real-time sensor feedback (e.g., from sensor 788, inspection cameras, or profile scanners) to maintain target conditions (e.g., bonding temperature) or correct detected deviations in geometry or quality.

In addition to real-time adjustments, control strategies employed by the control system (e.g., 114) may use historical data to manage parameters of the deposition head 410. For example, sensor feedback collected during deposition of previous layers can inform parameter adjustments (such as the power to heater 790 or the deposition speed) for deposition of subsequent layers to compensate for observed trends or errors. Predictive or feed-forward techniques may also be used, wherein the control system 114 adjusts operational parameters (e.g., deposition rate, traversal speed) proactively based on analysis of upcoming toolpath geometry stored in the build instructions, e.g., slowing traversal speed before reaching corners or modifying flow rates for infill/perimeter transitions to maintain consistent deposition dimensions.

Control strategies may also incorporate material models or use process feedback (e.g., pressure, motor torque) to anticipate and compensate for material variations, such as viscosity changes due to temperature or material inconsistencies, to ensure consistent deposition. For instance, the control system may include sensors or other circuitry configured to monitor torque for a metering pump motor. When an unexpected torque increase is detected (potentially indicating higher viscosity or a partial blockage), the control system configuration may cause one or more responses including temporarily increasing extruder temperature via dedicated heater(s) associated with the extruder barrel, slightly decreasing metering pump speed to reduce pressure, and/or alerting an operator. Conversely, a detected low torque may indicate excessively low viscosity, and the control system circuitry or programming may cause a decrease in temperature, metering pump speed to increase pressure, and/or notify an operator.

Similarly, one or more pressure sensors may be placed in the flow path, e.g., after the metering pumps and before any downstream manifold or mixer, to provide feedback on pressure being generated by the metering pumps or sensed within the manifold. The control system may be configured or programmed to respond to this pressure feedback by adjusting a speed of one or more extruder screws to maintain a desired inlet pressure for the corresponding metering pump(s), to optimize decoupling and to ensure consistent metering pump filling, or to monitor the overall health of the deposition system. For instance, the control system may be configured or programed to respond to feedback from one or more pressure sensors located downstream of each, or of one or more of, the metering pumps by modulating the speed of the corresponding extruder screw(s) to maintain an optimal inlet pressure for the metering pump(s).

Furthermore, one or more temperature sensor(s) may be employed to measure the temperature within each extruder barrel, providing critical feedback to maintain consistent melt conditions for the material being processed by the deposition head. Similarly, the control system may be configured or programmed to receive data from a profile scanner measuring the height and/or width of a deposited bead, evaluate the data to identify deviations from a target geometry of the deposited bead, and trigger adjustments in the metering pump speed or the deposition head traversal speed to correct the deviations in subsequent paths or layers.

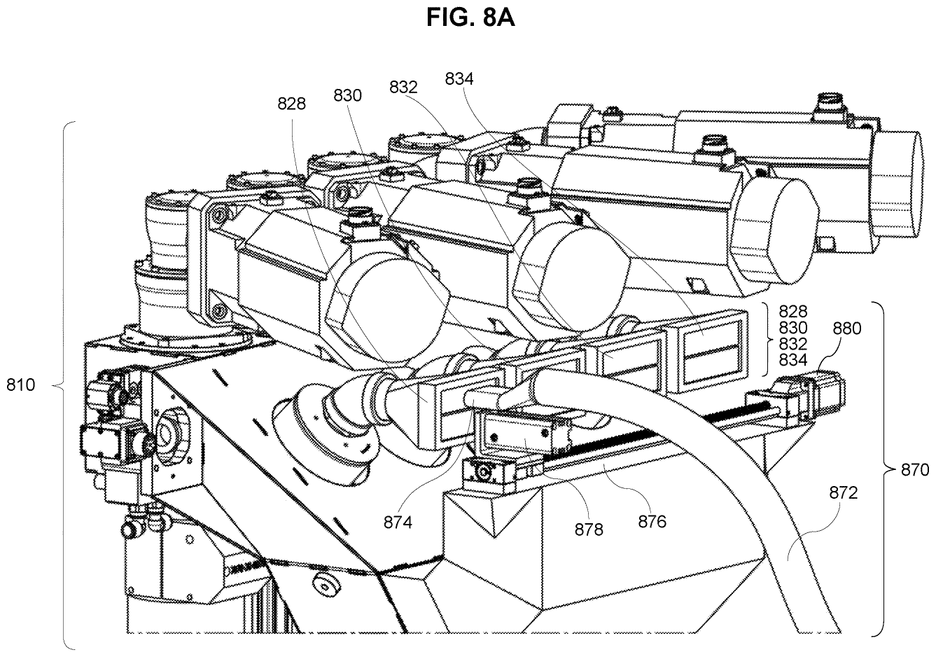

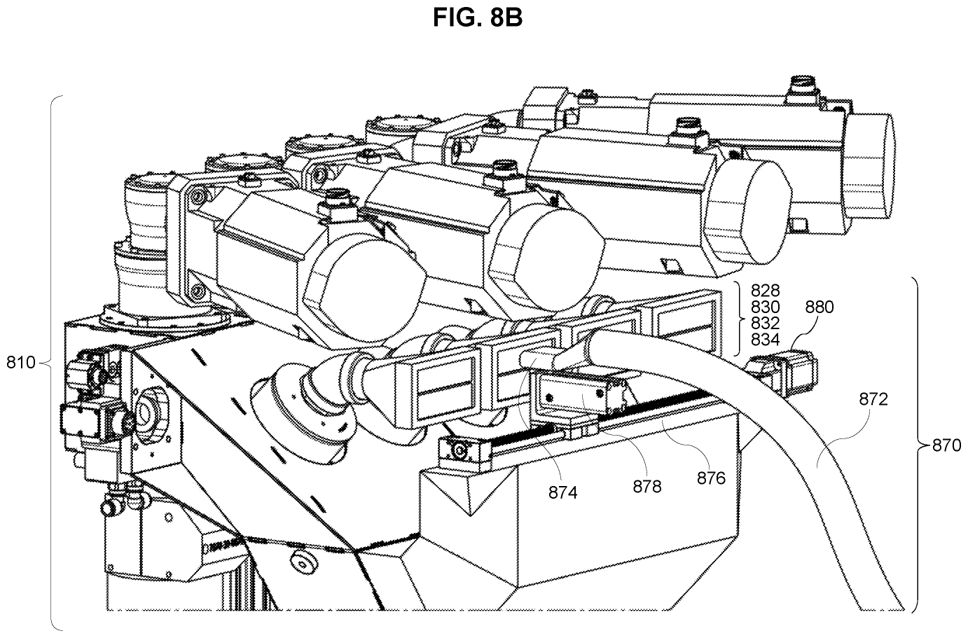

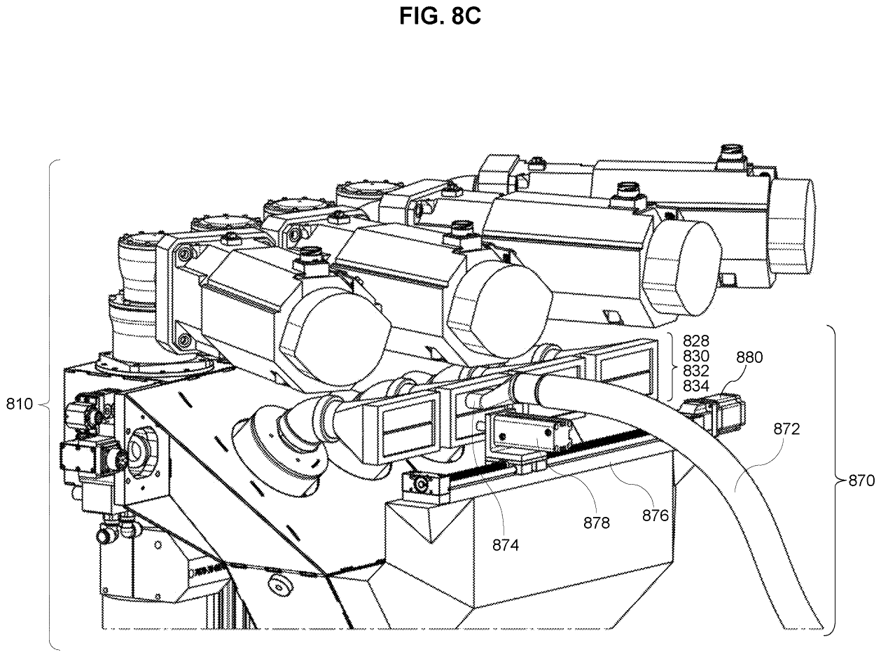

FIG. 8A, FIG. 8B, and FIG. 8C depict an embodiment of a deposition head 810, featuring a material feed selection system 870. The three figures illustrate the feed selection system's primary feed outlet 874 capable of supplying additive material to one or more material inlets at a time. The material feed selection system 870 includes a feed tube 872 for coupling the feed selection system 870 to an additive manufacturing material source (not shown), a feed outlet 874, and a material feed positioning mechanism. According to an embodiment, the material feed positioning mechanism may comprise a linear guide 876, an actuator such as a pneumatic cylinder 878 (e.g., for engagement with the material inlet or fine positioning), and a motor 880. In FIGS. 8A, 8B, 8C, metering pumps, associated pump motors, and a manifold or mixer are omitted for clarity. The material feed positioning mechanism is structured and configured to move the feed outlet 874 relative to respective material inlets 828, 830, 832, 834 (corresponding to, e.g., 628, 630, 632, 634) of the plurality of extruders. In an embodiment corresponding to FIGS. 8A, 8B, 8C, the feed outlet 874 is moved horizontally along the linear guide 876 by the motor 880, while the pneumatic cylinder 878 provides additional motion transverse to the linear guide for engagement with a currently used material inlet. This material feed positioning mechanism allows the feed outlet 874 to be positioned linearly relative to the extruder inlets. The feed outlet 874 can thus be positioned near the selected material inlet(s) to selectively supply material flow from the material source to the material inlet(s) 828, 830, 832, and/or 834 of one or more selected extruders. A control system (e.g., 114) commands the material feed selection system's material feed positioning mechanism, specifically the motor 880 and pneumatic cylinder 878, based on criteria received by the control system, including: extruder replenishment needs (e.g., determined by level sensors in optional hoppers), active extruder status based on deposition requirements, predetermined sequences, or material type selection. This linear shuttle system exemplifies one implementation where the material feed positioning mechanism moves the feed outlet relative to fixed inlets. Furthermore, a deposition head may comprise a plurality of material feed selection systems similar to 870. This configuration facilitates handling of multiple distinct material types simultaneously or sequentially, where each system 870 may be coupled to a distinct material source (where each material source may provide a different material type or color) and configured by the control system to deliver its specific material to a designated subset of the plurality of extruders.

It is understood that while FIG. 8A, FIG. 8B, and FIG. 8C depict a material feed positioning mechanism based on a linear guide 876 moving the feed outlet 874 relative to fixed material inlets, other configurations for achieving selective material supply via the material feed selection system 870 are also contemplated and fall within the scope of the claims. For instance, the relative movement may involve other structures for moving the feed outlet 874, such as using a material feed positioning mechanism comprising a rotary positioning structure to move the feed outlet 874, e.g., a rotary arm or turret mechanism pivoting or rotating the outlet 874 into alignment with a selected extruder inlet. Another embodiment may employ a material feed selection system configured with a feed outlet 874 fixed in position relative to the main structure of the deposition head 810. In such configuration, the relative movement required for selective supply may be achieved by a positioning mechanism configured to move the material inlets (e.g., by moving feed tubes attached to the material inlets) relative to the fixed feed outlet. Using such a material feed selection system (like 870, regardless of the specific positioning mechanism employed whether moving the outlet or moving the inlets) facilitates material management, especially when connected via feed tube 872 to a shared or large, off-head source. This approach simplifies handling, reduces on-head hopper requirements and weight, enables longer unattended operation, and promotes uniformity if drawing from a single material source batch. This selective supply capability complements control strategies using subsets of extruders by delivering material only to required or active material inlets (e.g., 628, 630, 632, 634).

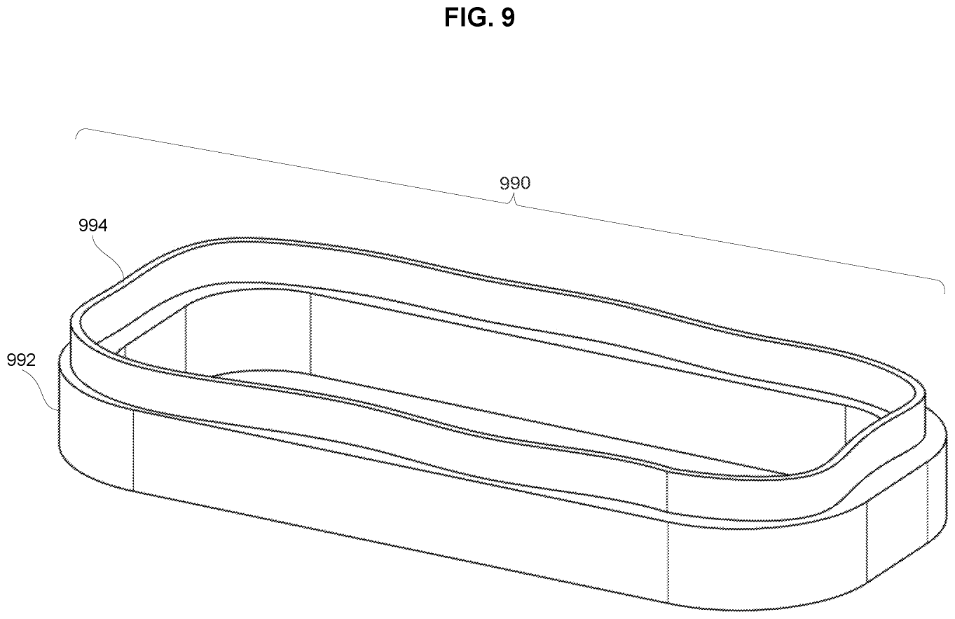

FIG. 9 illustrates an example part geometry 990 that benefits from the described deposition head capabilities. The part 990 includes a large base 992 suited for high-volume deposition and a thinner-walled upper section 994 requiring finer control. Many part geometries involve features requiring different deposition rates.

FIG. 10 is a block diagram illustrating relative position relationships between a deposition head, nozzle outlet, newly deposited material, substrate, and deposition surface. The newly deposited material is that just extruded from the nozzle outlet. The substrate is the structure/material immediately beneath the newly deposited layer (often previously deposited material, but could include support tooling, a prior part, or a build plate)-essentially forming a foundation for the current deposition. The deposition surface is the surface of the substrate upon which new material is extruded. While shown horizontally, these elements maintain their relationship regardless of orientation.

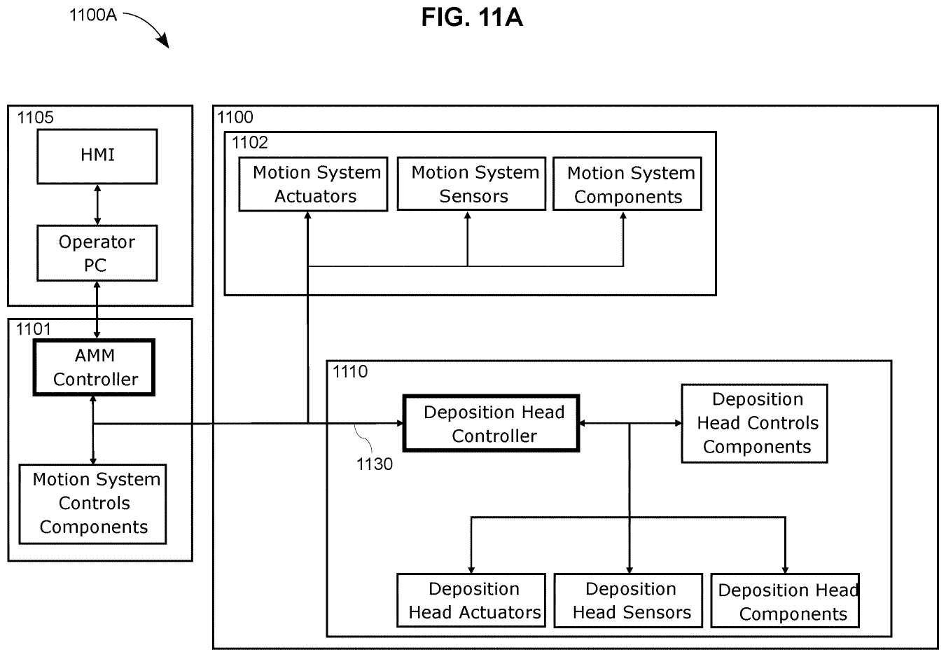

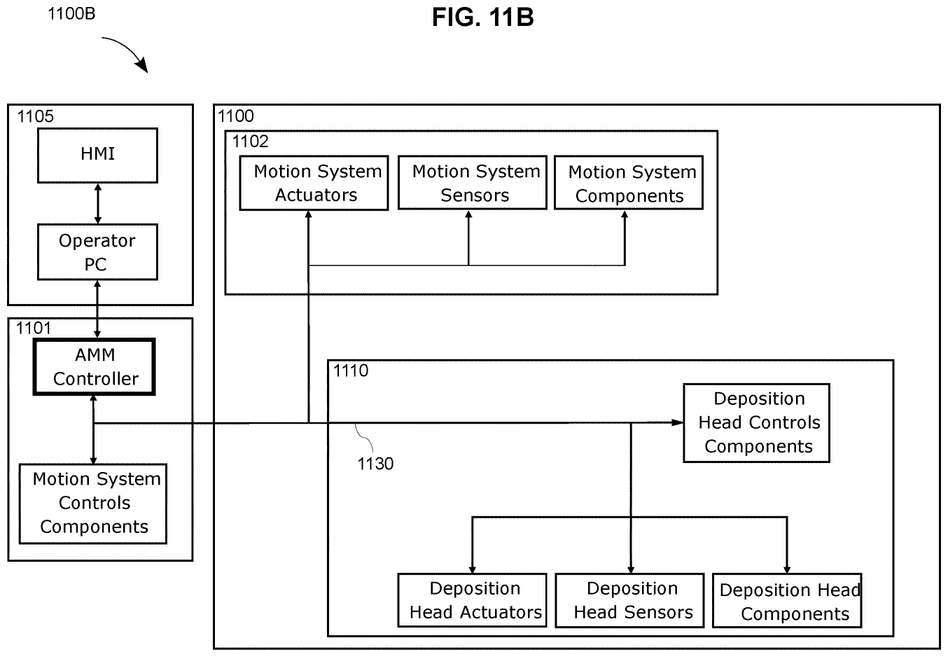

FIG. 11A and FIG. 11B illustrate two control system architectures 1100A, 1100B for controlling a deposition head 1110 and an AMM motion system 1102. FIG. 11A depicts a distributed control architecture 1100A, whereas FIG. 11B depicts a centralized control architecture 1100B.

In the distributed architecture 1100A shown in FIG. 11A, an AMM controller (e.g., a CNC or PLC) may reside in a control cabinet 1101 or may be located elsewhere within or associated with an AMM build cell. This location may also house associated motion system control hardware (e.g., motor drives, I/O modules). An operator station 1105, potentially located outside the build cell, typically includes an operator interface (such as a human-machine interface (HMI)) and may include an industrial PC communicatively coupled to the AMM controller for monitoring and command input. This AMM controller, in conjunction with the motion system control hardware, sends and receives signals to motion system actuators (including drive motors), other motion system components, and motion system sensors that comprise the motion system 1102. The AMM controller is responsible for overall system coordination, motion planning, and control of the AMM motion system. The AMM controller communicates high-level commands via a communication link 1130 (e.g., PROFINET, discrete wiring, Ethernet/IP, EtherCAT, CAN bus) to a Deposition Head Controller. Such high-level commands may include, for example, target deposition rates derived from build instructions, commands to activate or deactivate specific extruders, temperature setpoints for various heating zones (like extruder barrels or nozzle heaters), and activation signals for ancillary systems. This Deposition Head Controller is typically located on or integrated within the deposition head 1110 structure itself. This Deposition Head Controller receives the high-level commands from the main AMM controller and manages the real-time, local control of deposition head systems, including associated deposition head actuators, deposition head sensors, and other deposition head components. Together these managed systems perform operations including driving the plurality of extruder motors (e.g., 270, 272, 274, 276) and metering pump motors (e.g., 278, 280, 282, 284) to achieve commanded rates or pressures, controlling heaters (such as those associated with extruder barrels or the nozzle, potentially including localized heaters), operating ancillary components (such as actuating a compaction roller), controlling a reinforcement applicator (to apply reinforcement materials to the deposition materials), managing a material feed selection system (if present), and/or processing feedback from various head-mounted sensors. The head-mounted sensors may include temperature sensors (e.g., configured for monitoring substrate temperature), pressure sensors (e.g., configured for monitoring pressure downstream of pumps), level sensors (e.g., in local hoppers or for the material feed selection system), cameras (e.g., configured for quality monitoring), scanners (e.g., configured for geometric measurement), displacement sensors, and torque sensors (e.g., configured for sensing torque on pump motors). The deposition head controller interprets the desired deposition rate and other commands to precisely manage the speeds of the pumps and extruders, regulate temperatures, and coordinate ancillary functions, potentially using local feedback loops based on the processed sensor data. It also sends status information and sensor feedback back to the AMM controller via the communication link 1130.

FIG. 11B depicts a centralized control architecture 1100B. In this configuration, a primary AMM controller manages substantially all functions of both the AMM motion system and the deposition head 1110. More specifically, the primary AMM controller is configured or programmed to manage overall system coordination, motion control (controlling motion system actuators directly or via associated drive hardware), user interface functions (such as an operator human-machine interface (HMI)), and also directly performs real-time control of all deposition head actuators, sensors, and ancillary components. The primary AMM controller commands and receives feedback from the extruder motors (e.g., 270, 272, 274, 276), metering pump motors (e.g., 278, 280, 282, 284), deposition head heaters (including extruder barrel, nozzle, and potentially localized heaters), ancillary components (such as a compaction roller, reinforcement applicator, or material feed system), and processes signals from all head sensors (including, for example, temperature sensors like pressure sensors, level sensors, vision systems, and position/torque sensors). The communication links, represented conceptually by 1131, would connect the primary AMM controller directly to both the motion system actuators and the various deposition head systems, deposition head sensors, and other deposition head components, carrying all necessary real-time command and feedback signals. This architecture consolidates control logic into one primary unit but requires the main controller to handle all high-speed, real-time tasks for both motion and deposition.

These two FIGS. (11A and 11B) illustrate distinct approaches, with the distributed architecture (FIG. 11A) offering advantages in modularity and offloading of real-time tasks from the main controller, while the centralized architecture (FIG. 11B) simplifies the overall hardware configuration or software integration in some cases. Other hybrid architectures are also possible, as previously described. It should be understood that FIG. 11A and FIG. 11B are conceptual illustrations intended to show examples of distributed and centralized control architectures, respectively. Actual implementations may vary significantly; for instance, specific components may be located in different physical positions than depicted, interconnections between components may differ, certain illustrated components may not be present in all embodiments, and additional components not shown (omitted for clarity) may be included. Regardless of the specific distribution or implementation details, the overall control system coordinates motion and deposition functions, including managing extruder and pump outputs for precise deposition rates, controlling thermal conditions, and processing sensor feedback as described herein.

It is expressly contemplated that features described in relation to the various embodiments herein may be combined in ways not explicitly illustrated. For example, the material feed selection mechanism shown in FIG. 8 could be incorporated into a system using shared metering pumps as in FIG. 3, or the ancillary systems depicted in FIG. 7 could be added to the mixer configuration of FIG. 4. The scope of the disclosure is intended to encompass such combinations as would be apparent to one skilled in the art.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Exemplary embodiments are shown and described in the present disclosure. It is to be understood that the embodiments are capable of use in various other combinations and environments and are capable of changes or modifications within the scope of the inventive concept as expressed herein. Some such variations may include using programs stored on non-transitory computer-readable media to enable computers and/or computer systems to carry our part or all of the method variations discussed above. Such variations are not to be regarded as departure from the spirit and scope of the present disclosure, and all such modifications as would be obvious to one skilled in the art are intended to be included within the scope of the following claims.

1. A deposition head for an additive manufacturing machine, the deposition head comprising:
a plurality of extruders;
one or more metering pumps positioned in a flow path downstream of at least one extruder of the plurality of extruders, wherein the flow path directs additive manufacturing material from the at least one extruder through at least one metering pump of the one or more metering pumps;
a nozzle fluidly connected downstream of the one or more metering pumps; and
a mounting structure configured for attachment to a motion system of an additive manufacturing machine.

2. The deposition head of claim 1, wherein the deposition head is operatively coupled to a control system, the control system configured to control an output of the plurality of extruders and the one or more metering pumps to achieve a desired deposition rate.

3. The deposition head of claim 2, wherein the control system is integrated as part of the deposition head, or is distributed between the deposition head and the additive manufacturing machine.

4. The deposition head of claim 2, wherein the control system is configured to independently control the output of each extruder of the plurality of extruders and the one or more metering pumps.

5. The deposition head of claim 2, wherein the control system is configured to:
pre-select a subset of the plurality of extruders based on a maximum desired deposition rate for a build process, or configured to
activate a number of the plurality of extruders required to achieve a desired deposition rate, based on a current deposition rate and capacity thresholds for the extruders.

6. The deposition head of claim 2, wherein the control system is configured to control operational parameters including one or more of:
an additive manufacturing material deposition rate;
a deposition head traversal speed; and
a temperature of: additive manufacturing material within at least one of the extruders, additive manufacturing material within a metering pump of the one or more metering pumps, a portion of a substrate onto which additive manufacturing material is to be deposited, additive manufacturing material newly deposited from the nozzle, the deposition head, and/or the nozzle.

7. The deposition head of claim 6, wherein the control system is further configured to adjust at least one of the operational parameters based on at least one of: historical data from previous layers of deposited additive manufacturing material, predicted requirements based on upcoming geometry of a deposition path, and anticipated behavior of the additive manufacturing material.

8. The deposition head of claim 2, further comprising one or more sensors configured to provide feedback to the control system, the one or more sensors including any one or more of: an inspection camera, a laser displacement sensor, a profile scanner, a temperature sensor, a pressure sensor, a material level sensor, and a torque sensor.

9. The deposition head of claim 8, wherein the control system is configured to dynamically adjust an additive manufacturing material deposition rate, a deposition head traversal speed, and/or a temperature at one or more process locations, the adjustment based at least in part on the feedback from at least one of the one or more sensors.

10. The deposition head of claim 1, wherein at least two extruders of the plurality of extruders are configured to extrude the additive manufacturing material simultaneously.

11. The deposition head of claim 1, wherein the extruders are arranged in a functionally parallel configuration.

12. The deposition head of claim 1, wherein the at least one extruder of the plurality of extruders comprises a screw and a barrel.

13. The deposition head of claim 1, wherein the at least one extruder of the plurality of extruders is a pellet extruder, a filament extruder, a powder extruder, or a liquid resin extruder.

14. The deposition head of claim 1, wherein the plurality of extruders includes at least three pellet extruders.

15. The deposition head of claim 1, wherein each extruder of the plurality of extruders is operatively coupled to a respective metering pump of the one or more metering pumps.

16. The deposition head of claim 1, wherein the at least one metering pump of the one or more metering pumps comprises a positive displacement pump.

17. (canceled)

18. The deposition head of claim 16, wherein the positive displacement pump comprises a gear pump.

19. The deposition head of claim 1, wherein the at least one metering pump comprises moving elements configured to trap and positively displace volumes of the additive manufacturing material from an inlet side of the at least one metering pump to an outlet side of the at least one metering pump, such that the at least one metering pump substantially isolates pressure variations between the at least one extruder upstream of the inlet side and a downstream flow path connected to the outlet side, thereby mitigating backflow when outputs from a plurality of extruders or metering pumps are combined.

20. The deposition head of claim 1, wherein the at least one metering pump is configured to provide precise metering of the additive manufacturing material substantially independent of variations in operation of the at least one extruder upstream of the at least one metering pump to decouple the metering of the additive manufacturing material from feeding and melting of the additive manufacturing material.

21. The deposition head of claim 2, wherein the deposition head further comprises a mixer positioned downstream of at least two extruders of the plurality of extruders, wherein the mixer is fluidly coupled to receive and mix streams of additive manufacturing material output from the at least two extruders or from metering pumps, of the one or more metering pumps, that are in fluid connection with the at least two extruders.

22. The deposition head of claim 20, wherein the at least one metering pump is positioned in the flow path between the mixer and the nozzle.

23. The deposition head of claim 20, wherein the mixer is positioned in the flow path between the metering pumps, that are in fluid connection with the at least two extruders, and the nozzle.

24. The deposition head of claim 20, wherein the control system is further configured to control a relative output of each of the plurality of extruders and/or the at least one metering pump to achieve a predetermined material composition in the mixer.

25. The deposition head of claim 1, further comprising material inlets respectively corresponding to each of at least two extruders of the plurality of extruders;
a feed outlet fluidly connectable to an additive manufacturing material source; and a material feed positioning mechanism configured to move said feed outlet relative to the respective material inlets to selectively supply material flow from the material source to the material inlet(s) of one or more selected extruders of the plurality of extruders.

26. The deposition head of claim 25, wherein the material feed positioning mechanism comprises at least one of a linear guide, a linear actuator, or a rotary positioning structure, configured to move either the feed outlet relative to the material inlets or the material inlets relative to the feed outlet to achieve said selective supply.

27. The deposition head of claim 25, wherein the material feed positioning mechanism is configured to divert the additive manufacturing material to the one or more extruders of the plurality of extruders based on one or more of: a predetermined pattern, a desired deposition rate, sensor feedback, an anticipated deposition rate, and an additive manufacturing material type.

28. The deposition head of claim 1, further comprising a manifold configured to combine outputs of at least two of the extruders and/or outputs of at least two metering pumps of the one or more metering pumps, wherein an output of the manifold is fluidly connected to the nozzle.

29. The deposition head of claim 1, wherein the deposition head further comprises at least one of: a heating element, a cooling element, a compaction member, a surface treatment applicator, and a reinforcement applicator.

30.-56. (canceled)

57. A method of additive manufacturing, comprising:
providing a deposition head comprising:
a plurality of extruders,
one or more metering pumps positioned in a flow path downstream from at least one extruder of the plurality of extruders, and
a nozzle positioned downstream of the one or more metering pumps;
directing an additive manufacturing material from the at least one extruder to the nozzle through at least one metering pump of the one or more metering pumps;
controlling the output of the plurality of extruders and the one or more metering pumps with a control system to achieve a desired deposition rate at the nozzle;
depositing the additive manufacturing material through the nozzle onto a deposition surface; and
moving the deposition head, relative to the deposition surface.

58. The method of additive manufacturing of claim 57, wherein at least two extruders of the plurality of extruders are configured to extrude the additive manufacturing material simultaneously.

59. The method of additive manufacturing of claim 57, wherein at least a subset of the extruders are configured as pellet extruders.

60. The method of additive manufacturing of claim 57, wherein each extruder of the plurality of extruders is operatively coupled to a respective metering pump of the one or more metering pumps, or wherein at least two extruders of the plurality of extruders are operatively coupled to a single, shared metering pump.

61. The method of additive manufacturing of claim 57, wherein the plurality of extruders includes at least three extruders.

62. The method of additive manufacturing of claim 57, further comprising mixing the additive manufacturing material from at least two extruders of the plurality of extruders using a mixer positioned in a flow path upstream of the nozzle.
